(19) United States
(12) Patent Application Publication
(10) Pub. No.: US 2002/0002495 A1
(43) Pub. Date: Jan. 3, 2002

(54) INTEGRATED PHARMACEUTICAL ACCOUNTS MANAGEMENT SYSTEM AND METHOD

(75) Inventor: Richard O Ullman, Wayne, NJ (US)

Correspondence Address: Jonathan, Parks, Kirkpatrick & Lockhart LLP, 535 Smithfield Street, Pittsburgh, PA, 15222, US, jparks@kl.com, 412.355.6288, 412.355.6501

(73) Assignee: NPAX, Inc., Clifton, 07013 (US)

(21) Appl. No.: 09/574,780

(22) Filed: May 19, 2000

(51) Int. Cl. G06F 17/60; G06G 1/12

(52) U.S. Cl. 705/21; 705/16

(57) ABSTRACT

### Abstract of Disclosure

An integrated suite of services for consumers, service providers and manufacturers in the pharmaceutical industry is disclosed. The present invention utilizes one or more of the NCPDP standard formats and adopts the switch for an integrated system of, for example, instant adjudication of prescriptions, consumer data warehousing and/or incentive rewards for the consumer. A participating consumer with one card, can instantly purchase pharmaceuticals and charge the transaction to a credit card and earn and apply savings dollars redeemable for pharmaceutical purchases. For a participating service provider, instant adjudication and instant validation of consumer eligibility can be performed. Moreover, a service provider may receive messages related to the patient's medications. Significantly, data is recorded for consumers even when consumers make the pharmaceutical purchase with cash. The system includes a unique card issued to participating consumers. The card is adapted to encode conventional credit or debit card information specific to the participating consumer so that the consumer can consummate a transaction for the purchase of pharmaceuticals without possession of an additional credit card. The system further includes a host processor coupled to the point of sale at the service provider through a leased line or public switch network or the like. When a customer performs a pharmaceutical transaction at the point of sale of the service provider, the host processor coordinates any benefits and data with other prescription benefit management systems through messages transmitted and received from any primary or secondary carrier systems. The host processor further is adapted to facilitate real-time adjudication of claims and checks for any dangerous drug-to-drug interactions. The host processor additionally facilitates any financial processing including the accumulation and redemption of any bonus dollars earned by the consumer. Furthermore, since the card used by the consumer can be encoded with credit or debit card information, the host processor determines the desired payment method and performs the actual financial transaction. Even if the transaction at the point of sale is a cash purchase, the consumer may desire to use his unique card for the accrual of bonus dollars. Therefore, data concerning the transaction (i.e., pharmacy number, prescription number, etc.) can be recorded even for transactions conducted with cash.

### Background of Invention

The invention relates generally to the field of consumer prescription and other healthcare programs and more particularly to an integrated consumer rewards program for prescription medication users.

Traditional methods of marketing and promotion for pharmaceutical companies and retail pharmacies have called for merchants to make announcements through many media avenues. These avenues include television, radio, newspapers and magazines. The announcements are often spoken as with radio, or written. These methods are usually very expensive, very time-consuming, and often have to be paid for in advance of, and without any guarantee of future sales. Air-time and periodical space are often sold at a premium. Designing advertisements, doing research to define the exact target audience, and choosing where, when and how to place the advertisements are burdensome. This is sometimes so complicated and so demanding that additional employees or outside agencies are often hired to take care of such details.

An alternative method of marketing is the issuance of redeemable coupons. However, the management of coupon verification, shuffling, and redemption is also an administrative nightmare. Many printed coupons are collected by consumers, often in quantities of hundreds or even thousands of small pieces of paper, and are often later presented to merchants for redemption. The merchants collect the coupons as they are presented, verify that the presented coupons are valid, honor the discounts, and later sort the coupons. Sorting the coupons is a very time-consuming process and usually is performed at the end of the day so as not to delay consumers. Coupons issued by manufacturers or other third parties are compiled and then sent to their respective issuers for redemption. In this case, merchants have the disadvantage of having to wait to receive full payment from the manufacturers or third-party-coupon issuers for the goods that were sold earlier at a discount. Reimbursement can take weeks, even months, and such delays can have a detrimental effect on a merchant's cash flow. The merchant often buys goods from the manufacturer in advance and has to sell them to recoup the investment and make a profit. The longer the delays are, the longer the merchant's turnaround time on their investment is and the longer restocking ability is delayed. Consumers, on the other hand, become confused with collecting so many coupons that oftentimes they find that several coupons have been left at home, some time during shopping or checkout. Furthermore, the use of the coupon method creates massive paper waste. Many times, coupons are printed and never redeemed. The ones that are redeemed are not always recycled because of human disregard or inconvenience.

Nearly all merchants" sale prices must increase dramatically to counter the expenses incurred by the use of either of the above mentioned promotional techniques. The retail pharmacy industry, ranging from small and medium sized pharmacies averaging several prescriptions per hour to large hospitals, Internet and mail order pharmacies averaging thousands of prescriptions per hour, is particularly sensitive to promotional expenses.

What is needed, therefore, is an effective consumer rewards program scalable for all merchants in the retail pharmaceutical industry.

### Summary of Invention

Disclosed herein is a system, which generally contains all the aspects listed within this paragraph but in no way should be deemed as being limited solely to such content. The present invention provides an integrated suite of services for consumers, service providers and manufacturers in the pharmaceutical industry. The present invention utilizes one or more of the standard formats of the National Council for Prescription Drug Programs ("NCPDP") and adopts the switch for an integrated system of, for example, instant adjudication of prescriptions, consumer data warehousing and/or incentive rewards for the consumer. As designed, a participating consumer with one card, can instantly purchase pharmaceuticals and charge the transaction to a credit card and earn and apply savings dollars redeemable for pharmaceutical purchases. For a participating service provider, instant adjudication and instant validation of consumer eligibility can be performed so that the pharmaceutical transaction may be approved or rejected. Moreover, a service provider may receive messages related to the patient's medications. Significantly, data may be recorded on consumer's transactions in the aggregate or individually even when consumers make the pharmaceutical purchase with cash.

The system includes a unique membership card issued to participating consumers. The card is adapted to encode conventional credit or debit card information specific to the participating consumer so that the consumer can consummate a transaction for the purchase of pharmaceuticals without possession of that credit or debit card. The system further includes a host processor coupled to the point of sale at the service provider through a leased line or public switch network or the like. When a customer performs a pharmaceutical transaction at the point of sale of the service provider, the host processor coordinates any benefits and data with other prescription benefit management systems through messages transmitted and received from any primary or secondary carrier systems. The host processor further is adapted to facilitate real-time adjudication of claims and checks for any potential drug-to-drug interactions. The host processor additionally facilitates any financial processing including the accumulation and redemption of any bonus dollars earned by the consumer. Furthermore, since the card used by the consumer can be encoded with credit or debit card information, the host processor determines the desired payment method and facilitates the actual financial transaction. Even if the transaction at the point of sale is a cash purchase, the consumer may desire to use his unique card for the accrual of bonus dollars. Therefore, data concerning the transaction (i.e., pharmacy number, prescription number, etc.) can be recorded even for transactions conducted with cash.

### Brief Description of Drawings

A more complete understanding of the present invention may be obtained by considering the following description in conjunction with the drawings in which:

Figure 1 is a schematic diagram of a system in accordance with the principles of the present invention.

Figure 2 is a flowchart of a typical transaction in accordance with the principles of the present invention.

### Detailed Description

Before discussing the present invention, it is helpful to look at the operation of the pharmaceutical industry. Pharmaceutical payments represent one of the single largest expenditures in the United States today. Although the pharmaceutical industry is primarily insurance-based, there is a significant portion of the payments originating from consumers without insurance that may be termed "cash-based." That is, although a majority of consumers rely on insurance for full or partial payment of their pharmaceutical needs, there is a significant portion of consumers who have no insurance or discount plans. Two basic health insurance systems are currently in operation: the indemnity system in which patients are required to make payment to service providers and then claim and collect from insurers; and the third-party payment system in which service providers look directly to insurers or other obligors for primary payment, in addition to collecting optional co-payments directly from patients.

The pharmaceutical industry is primarily a third-party payment system. Pharmacies must therefore rely on the payment practices and creditworthiness of the payors and obligors to collect for services provided to customers by a third-party payment plan. Recent improvements in the claims processing system for the pharmaceutical industry, including the introduction of electronic, on-line adjudication have added significant reliability to the third-party payment system.

In recent years, the pharmaceutical industry's claim processing system has been completely reformed, having shifted from a variety of paper-based forms to a uniform claim form and then in 1986 to an electronic on-line system. Now, on-line adjudication of the validity of claims is possible for almost all pharmacies, regardless of size. Pharmaceutical prescription claims processing is thus at the forefront of on-line medical claims processing. With the automation of Medicaid and the continuing automation of service providers, it is likely that almost all claims transactions will be processed electronically within the next three years.

The prescription claims processing and payment system involves one or more entities providing one or more of a variety of functions which include: service provider; plan sponsor; obligor; administrator; payor; processor; switch; and software supplier, each as described below. Importantly, many of the largest industry participants in the claims processing system perform multiple functions such as obligor, payor, administrator, and processor. It is important to understand the functions and/or the combinations of functions these entities provide to be able to recognize the level of detail and analysis that is inherent in correctly managing the instant processing of healthcare claims.

A service provider is an entity that provides healthcare services. In the case of pharmaceutical services, service providers include independent pharmacies, drug store chains, supermarket combinations (pharmacies inside supermarkets), mass volume retailers, mail order and Internet pharmacies.

A plan sponsor is typically an entity establishing or maintaining healthcare benefits. The function of a plan sponsor is to represent those persons to be insured or to receive healthcare benefits. Plan sponsors include commercial insurance companies, health maintenance organizations ("HMOs"), preferred provider organizations ("PPOs"), Blue Cross/Blue Shield entities, affinity groups, unions, government entitlement programs (such as Medicaid), self-funded private and government employers (i.e., employers that take on the direct responsibility and liability for the healthcare claims of their employees rather than purchasing third-party coverage for such claims from commercial insurers), and private and governmental employers that are not self-funded.

An obligor is an entity that is generally considered as ultimately responsible for making payment for the healthcare services provided on its behalf and for the insurance risk associated with a plan. Plan sponsors may also be obligors, as is the case with self-insured corporations. The current on-line pharmaceutical network recognizes an estimated 3,500 entities as obligors. An obligor may also function as an administrator, as is the case with certain insurance carriers, or as a payor or processor. Most of the obligors recognized by the on-line network utilize separate entities that perform these functions to facilitate their prescription programs.

An administrator, often called a third-party administrator ("TPA"), services prescription plans in connection with self-funded healthcare benefits or insurance programs. A plan is a set of parameters that indicates the eligibility and types of healthcare coverage of a particular group of eligible persons. TPAs also maintain service provider networks and enroll and contract with pharmacies on behalf of obligors. Some TPAs also provide payment services for obligors. They bill the obligor for approved claims on a regular basis and remit payments to the service provider on behalf of the plan sponsor. TPAs may subcontract certain functions to payors and processors.

A payor is an entity, usually a TPA or obligor, that issues payments to service providers on behalf of obligors. A payor also provides obligors with management reports and sends service providers, along with payment, a remittance advice ("RA") (i.e., a report outlining which transactions have been handled and positively adjudicated in the indicated processing cycle, along with any adjustments and processing charges) together with the payment. The total indicated on an RA should equal the amount of the payment, which it accompanies.

A processor is an entity that provides on-line and paper-based manual claim adjudication services. A processor's responsibility is to adjudicate claims by applying the plan parameters (i.e., determining the acceptability of a claim based, for example, on a claimant's eligibility and coverage of the medication), and then to report the results to the TPA or plan sponsor on a scheduled basis. Each payor selects a standard reimbursement payment cycle, typically 10, 14 or 30 days, during which the processor adjudicates claims submitted over the on-line network by service providers. At the end of each processing cycle, processors "rule-off" the accumulated claims and report the results. They then forward their "experience" tapes for the relevant period, which itemize all of the approved transactions, to each TPA or plan sponsor who reviews the tapes and then makes payments, directly or indirectly, to the service providers.

A switch provides the means for relaying electronic claims data from service providers to processors. Based upon a Bank Identification Number ("BIN"), a unique number issued by the American National Standards Institute which identifies the appropriate processor, the switch forwards messages from the service provider to the processor and returns the responses. In general, a switch does not provide or alter the content of any of the messages it processes, but is merely a communications conduit.

A large number of companies supply software packages to service providers for such purposes as automated inputting and formatting of electronic claims. Although the performance of the competing software systems vary dramatically, the functions they perform and the formats used to transmit third-party pharmacy claims are essentially identical because all electronic messages must conform to one or more of the standard electronic message formats set by the National Council for Prescription Drug Programs ("NCPDP") of 4201 North 24th Street, Phoenix, Ariz. 85016-6268. NCPDP provides standard formats for many electronically transmitted message formats, including, for example, the following formats which specify field number, field name, field type, field format, and field length positions: (1) transaction format for prescription, which includes fields such as BIN, version number, transaction code, processor code, pharmacy number, group number, cardholder identification number, date of fill, and prescription number; (2) response format for eligibility verification or prescription claim, which includes fields such as BIN, transaction code, response status, and response data; and (3)reversal format, which includes fields such as BIN, transaction code, processor code, pharmacy identification number, date of fill, and prescription number. Other NCPDP standard message formats include a worker's compensation claim format, a Medicaid claim format, a claim payable response format, and a claim captured response format.

The present invention utilizes the NCPDP standard format and adopts the switch for an integrated system of instant adjudication, consumer data warehousing and incentive rewards for the consumer. As further background, the operation of the conventional pharmaceutical on-line claims and payment processing network is described.

After a patient or customer presents a pharmacy with a prescription, the pharmacist utilizes an in-house computer prescription system and gathers the necessary information about the prescription, the patient, and his insurance, discount or savings coverage. The pharmacist inputs this information into a personal computer. This information is then transmitted in one of three ways: (a) direct transmission to a high volume obligor; (b) direct transmission to a processor who represents one or more TPAs or plan sponsors (most processors handle input data for a variety of TPAs and plan sponsors); or (c)over the on-line network via switches which direct the outgoing messages to the appropriate obligors or processors.

In response to the pharmacy's claim, an NCPDP formatted adjudication message is then transmitted by the processor receiving the claim back through the same channels to the originating pharmacy. An adjudication is an evaluation of the validity of a claim by reference to the patient eligibility and plan design, such as drug products allowed, types of permitted drug interactions and dosages, and drug prices which will be reimbursed by the particular plan. The adjudication message normally contains adjudication/authorization information, the unique prescription number and the previously agreed upon price for that prescription. An adjudication message transmitted by a processor indicates the following three items of information about the claim: (i) that it has been received by the processor; (ii) that it has been reviewed by the processor against specifications established by the TPA and agreed upon by the obligor; and (iii)it has been indicated for disposition in one of three ways: approval, rejection or pending status.

Once a service provider receives a positive on-line adjudication response to a claim, it logs the claim as an approved claim receivable, dispenses the drug based on instructions from the doctor and awaits payment from the payor.

As explained above, each formatted message and response in the on-line system adheres to standard specifications set by the NCPDP. All responses therefore share a number of common functional traits. Generally, all responses verify a match between the information submitted and the terms of the plans. They also check for drug interactions and appropriate dosage levels. Additionally, they provide the price of the prescription based upon the National Drug Code's prescription identification system and the industry standard prices published by companies such as Medispan of Indianapolis, Ind.

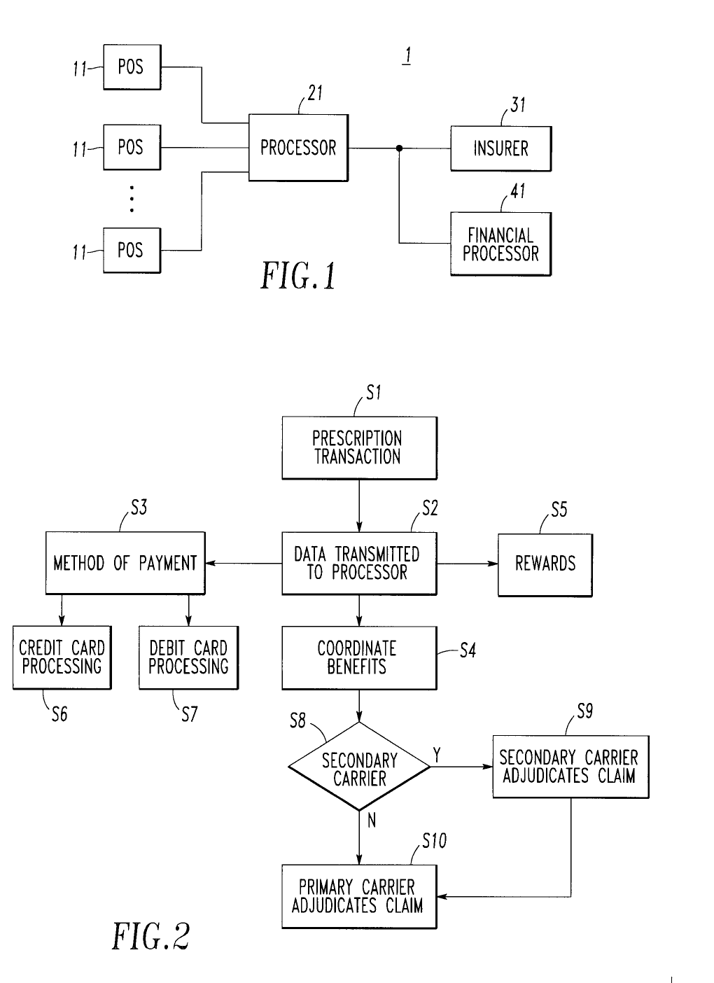

Referring to Figure 1, there is shown a schematic diagram of a system 1 in accordance with the principles of the invention. A plurality of Point of Sale ("POS")11 typically reside at participating service providers, typically pharmacies, and may include an entry device and a personal computer. Transaction data, such as the pharmacy number and the prescription number, is entered manually by the pharmacist through the keyboard into the personal computer. The entry device may also be a bar code reader or a magnetic stripe reader. The POS may also include a bonus dollars output device in the form of an electronic readout device or small printer, which may show to the consumer the earned bonus dollars for the transaction. The display or printer may also indicate the total bonus dollars earned to date by the consumer.

A processor 21 is coupled to the POS 11 by conventional means such as a leased network or a public switched network. The processor represents an entity that may include a computer or manual adjudication services. The processor also includes a memory for storing guidelines for performing adjudication on any claims that are transmitted to the processor from any POS. When an adjudication message is received by the processor, the processor retrieves the corresponding guidelines for the participating plan and determines the acceptability of the claim based on factors such as the consumer's eligibility, drug-to-drug interactions and price.

The processor 21 is further coupled to an insurer 31 and a financial processor 41. In one embodiment, the insurer is not constantly coupled to the processor. The processor and the insurer may be only periodically coupled for updates of the TPA guidelines and to make electronic payments. The insurer additionally periodically audits the processor for conforming to TPA guidelines. In an alternative embodiment, the insurer is constantly coupled to the processor for instant updates to the latest guidelines and to settle financial transactions between the two entities.

A financial processor 41 is further coupled to the processor. The financial processor is responsible for processing any credit card or debit card transactions and manages the rewards program. The financial processor is adapted to interface with a number of credit card transaction warehouses for near instant approval of credit card and debit card transactions. Upon successful completion of a credit card or debit card transaction, the financial processor transmits a successfully completed message to the processor who then returns it to the POS.

Referring to Figure 2, there is shown a flowchart diagram illustrating the operation of the system of the present invention for a typical adjudication. It should be noted that the steps outlined below may be performed sequentially or concurrently. In step S1, a prescription transaction occurs at a point of sale. A pharmacist or clerk enters the transaction and data is transmitted to the processor as an adjudication message in step S2. The processor subsequently performs three steps. In step S3, the processor abstracts financial data from the adjudication message and determines the method of payment. The financial data may include credit card or debit card number, check cashing card, or may indicate a cash transaction. Recall that the unique card assigned to each participating consumer is encoded with their preferred method of payment. For instance, a consumer's credit card number is encoded directly onto the card so that the consumer does not have to fumble for a separate credit card to financially consummate the transaction. Similarly, a consumer's debit card number may also be encoded onto the card and transmitted as part of the adjudication formatted message. In steps S6 and S7, the appropriate financial processing is completed by credit card processing or debit card processing.

In step S4, the adjudication formatted message is abstracted to determine whether coordination of benefits between any primary insurance carriers and secondary insurance carriers required for the transaction. If a secondary carrier is required for full adjudication of the claim in step S8, the balance of the transaction is transmitted to the secondary carrier for adjudication in step S9. Otherwise, the full claim is adjudicated by the primary carrier in step S10. It should be noted that the coordination of benefits between the primary and any secondary carrier may also include coordination with the rewards program to be described below. The additional coordination of benefits may be required in situations where the primary insurance plan requires significant deductible contributions from the consumer, maximum benefit allowances or excludes certain necessary items (e.g., "lifestyle" medications such as obesity or hair loss treatments).

In addition to the financial processing and coordination of benefits, in step S5, rewards are earned and adjusted for the consumer's individual rewards account. Participating consumers can accumulate cash rebates, typically good for, but not limited to, future purchases of medication (prescription or over-the-counter) and other healthcare-related services. All of the rewards earned by one participating consumer are accumulated in one account for the particular consumer. At any time, the consumer may apply all or part of the balance of his account as a credit towards any qualified purchase. Additionally, the consumer may be given the option to transfer all or some of the accrued balances in the account to another consumer. For instance, a spouse may transfer accrued rewards balance to the other spouse or children or other dependents for emergency pharmaceutical purchases or other healthcare-related services as the need arises.

Rewards are determined as a variable percentage of certain qualified purchases. Additionally, the program is flexible to allow higher incentives for a select group of goods so that a full marketing plan can be built around the rewards program. Furthermore, the accrual of balances in a consumer's rewards account keeps a consumer's loyalty so that he or she will more likely seek out a participating service provider. Even for the participating consumer who lacks a prescription benefit plan, the financial processing occurs concurrently with the coordination of benefits so that the processor can record consumer data concerning the purchase. By tracking consumer habits and purchase history, the processor and other parties are able to offer targeted marketing and incentive programs tailored to the desired consumers. In addition, programs benefiting consumers can be developed by aggregating the data across consumers who are both on and not on prescription plans.

Additionally, a participating consumer is likely to use the card for the purpose of earning rewards dollars even when he or she consummates a transaction in cash. Consequently, a processor can warehouse data associated with transactions even when the transaction is performed with a cash purchase. Such data may include the pharmaceutical drug ID, the quantity of the pharmaceutical drug, the dosage units and the price paid. The data is subsequently stored and keyed to the consumer in a conventional database or other storing means.

The system described above has numerous marketing advantages for participating service providers. Participation in the rewards program can be an effective advertising program and draw in new consumers. Participating consumers will have incentives to increase the balance in their rewards account by visiting participating service providers in lieu of other service providers. Additionally, service providers and processors can track consumer purchasing histories and preferences with every pharmaceutical transaction and tailor future marketing efforts and rewards program towards specific types of consumers. Programs may be developed by aggregating data across consumers both on and not on prescription plans. A comprehensive data set across a critical mass in sufficient sizes offers targeted marketing programs. Data on specific pharmaceutical utilization may be segmented demographically (i.e., age, gender, geographic location, etc.) to target market to a broader population with the same characteristics. Furthermore, by increasing the percentage of the transaction which accrues to the rewards balance, service providers and processors can provide effective incentives for a consumer to try new products. Finally, in conventional cash-back programs, the consumer is rewarded with cash which the consumer can use for making purchases of any goods at any retailer. In the rewards program described above, however, the consumer is directed foremost to spending balances accrued on his rewards account for the purchase of other pharmaceutical goods or other health-related products or services. Therefore, rewards are fed back into the system described herein so that the rewards program can be eventually self-perpetuating.

Numerous modifications and alternative embodiments of the invention will be apparent to those skilled in the art in view of the foregoing description. Accordingly, this description is to be construed as illustrative only and is for the purpose of teaching those skilled in the art the best mode of carrying out the invention and is not intended to illustrate all possible forms thereof. It is also understood that the words used are words of description, rather than limitation, and that details of the structure may be varied substantially without departing from the spirit of the invention and the exclusive use of all modifications which come within the scope of the appended claims is reserved.

Claims

A system for managing pharmaceutical accounts comprising: a plurality of points of sale, said points of sale adapted for transacting pharmaceutical sales with consumers; a processor coupled to said plurality of points of sale, said processor adapted to adjudicate claims associated with said pharmaceutical sales; and a financial processor coupled to said processor for processing any electronic financial transactions associated with said pharmaceutical sales; whereby a percentage of said pharmaceutical sales is credited to a rewards account for said consumers.

The system of claim 1, further comprising an insurer coupled to said processor for auditing said claims.

The system according to claim 1, wherein said processor is further adapted to coordinate benefits with multiple insurers.

The system according to claim 3, wherein said processor is further adapted to coordinate benefits with primary carriers.

The system according to claim 4, wherein said processor is further adapted to coordinate benefits with secondary carriers.

The system according to claim 1, wherein value of said rewards account is adapted for credit for said pharmaceutical sales.

The system according to claim 1, wherein value of said rewards account is adapted for credit for health-related services.

The system according to claim 1, wherein said processor is further adapted for identifying a method of payment associated with said pharmaceutical sales.

The system according to claim 1, wherein said processor and said points of sale are coupled via a leased line.

The system according to claim 1, wherein said processor and said points of sale are coupled via a public switch network.

The system according to claim 1, wherein said processor includes a memory for storing archived information associated with said pharmaceutical sales keyed to individual consumers.

The system according to claim 11, wherein said pharmaceutical sales may be aggregated across said consumers on various benefit plans.

A method of managing pharmaceutical sales to consumers, the method comprising the steps of: receiving an electronically transmitted adjudication message; identifying a method of payment associated with the adjudication message; processing said method of payment; adjudicating claims associated with the adjudication message; and crediting a rewards account associated with said consumers.

The method according to claim 13, wherein said electronically transmitted adjudication message is in NCPDP format.

The method according to claim 13, wherein said crediting step includes crediting said rewards account with a percentage of value of said pharmaceutical sale.

The method according to claim 13, wherein said percentage is variable.

The method according to claim 13, wherein said method of payment is credit card.

The method according to claim 13, wherein said method of payment is debit card.

The method according to claim 13, wherein said method of payment is cash.
